(19) United States
(12) Patent Application Publication
(10) Pub. No.: US 2014/0251201 A1
(43) Pub. Date: Sep. 11, 2014

(54) RIFLE FLAGPOLE

(71) Applicants: Gregory Daniel Lingo, Hamilton, IN (US); Ralph Herbert Lingo, Hamilton, IN (US)

(72) Inventors: Gregory Daniel Lingo, Hamilton, IN (US); Ralph Herbert Lingo, Hamilton, IN (US)

(21) Appl. No.: 13/792,531

(22) Filed: Mar. 11, 2013

(51) Int. Cl. G09F 17/00

(52) U.S. Cl. CPC G09F 17/00
USPC 116/173

(57) ABSTRACT

A rifle shaped flagpole is adapted to carry a flag and to be supported on a flagpole holder. The flagpole includes a barrel portion and a stock portion, and the barrel portion extends longitudinally beyond a forestock part of the stock portion. An elongate rod extends from a butt part on the stock portion in a direction generally opposite the barrel portion. One end of the rod is secured in a bore in the stock portion at the butt part, and the other rod end is adapted to be received in an elongate bore of a flagpole holder. A flag may be attached to the flagpole at an eyelet on the barrel portion and an eyelet on the stock portion. Each eyelet is preferably part of an eye bolt having a threaded portion, and the threaded portions thereof extend through the respective barrel and stock portions and form aiming sights.

### CROSS REFERENCE TO RELATED APPLICATIONS

This is a continuation-in-part of and claims priority of application Ser. No. 29/421,537 filed Aug. 9, 2012, the disclosure of which is hereby incorporated herein by reference.

### BACKGROUND OF THE INVENTION

1. Field of the Invention

The present invention relates to the field of flagpoles used for displaying flags. More particularly, the present invention relates to a rifle shaped flagpole adapted to be supported by common flagpole brackets and holders.

2. Background

Flagpoles have been and are today commonly used for carrying and displaying flags. The flagpoles are oftentimes selectively mounted to a flagpole holder or bracket which is itself secured to a house, building, boat, vehicle and other structures. The flagpole is typically long and rod shaped, and the terminal end thereof is adapted to be received in a bore of the flagpole holder. The flagpole holder and bore thereof is typically mounted at an angle from the vertical such that the flagpole extends horizontally or, preferably, at an angle between the horizontal and the vertical and such that a flag attached to the flagpole hangs generally downwardly therefrom.

### SUMMARY OF THE INVENTION

A need has been found for attaching and displaying flags from a flagpole which is shaped like and has the appearance of a rifle. A need has therefore also been found for a rifle shaped flagpole which is adapted to early a flag and which is generally easily and efficiently mounted on and supported by a flagpole holder. Accordingly, the object of the present invention is to provide a rifle shaped flagpole which is adapted to carry a flag and which is supported on flagpole holder.

In one form thereof, the present invention is directed to a rifle shaped flagpole adapted to carry a flag and be supported on a flagpole holder having an elongate bore. The flagpole includes an elongate barrel portion and a stock portion. The stock portion includes a forestock part and a butt part at opposing ends thereof. The barrel portion extends longitudinally beyond the forestock part. An elongate rod extends from the stock portion and is adapted to be received in a flagpole holder elongate bore.

Preferably, a barrel eyelet is provided near a barrel muzzle end on the barrel portion and a stock eyelet is provided on the stock portion whereby a flag can be attached to the eyelets. The barrel eyelet is part of an eye bolt fastened to the barrel portion and the stock eyelet is part of an eye bolt fastened to said stock portion. The barrel eye bolt includes a threaded portion extending through the barrel and forms an aiming sight, and the stock eye bolt includes a threaded portion extending through the stock and forms an aiming sight. The stock eyelet threaded portion can extend through both the stock portion and the barrel portion whereby the stock portion and the barrel portion can be secured to one another.

Also preferably, the elongate rod extends longitudinally beyond the stock portion butt part and in a direction generally opposite the barrel portion.

Yet more preferably, the elongate rod has a round shaped surface, a diameter of about one inch and extends from the butt part about four inches.

One terminal end of the elongate rod is preferably received and secured in a bore extending into the stock portion from the butt part and another terminal end of the elongate rod extends from the stock portion butt part and is adapted to be received in a flagpole holder elongate bore.

Also preferably, a barrel eyelet is provided near a barrel muzzle end on the barrel portion and a stock eyelet is provided on the stock portion whereby a flag can be attached to said eyelets. The barrel eyelet is part of an eye bolt fastened to the barrel portion. The barrel eye bolt includes a portion extending through the barrel and forming an aiming sight. The stock eyelet is part of an eye bolt having a portion extending through the stock portion and the barrel portion thereby securing the stock portion and the barrel portion to one another and also forming an aiming sight.

### BRIEF DESCRIPTION OF THE DRAWINGS

The above mentioned and other features of this invention, and the manner of attaining them, will become more apparent and the invention itself will be better understood by reference to the following description of the embodiments of the invention taken in conjunction with the accompanying drawings, wherein:

FIG. 1 is a perspective view of a rifle shaped flagpole constructed in accordance with the principles of the present invention and with its elongate rod thereof received in a flagpole holder;

FIG. 2 is a right side elevation view of the flagpole shown in FIG. 1;

FIG. 3 is a left side elevation view of the flagpole shown in FIG. 1;

FIG. 4 is a top plan view of the flagpole shown in FIG. 1;

FIG. 5 is a bottom plan view of the flagpole shown in FIG. 1;

FIG. 6 is a rear elevation view of the flagpole shown in FIG. 1;

FIG. 7 is a front elevation view of the flagpole shown in FIG. 1;

FIG. 8 is a perspective view of another embodiment of a rifle shaped flagpole constructed in accordance with the principles of the present invention with its elongate rod thereof received in a flagpole holder; and,

FIG. 9 is a left side elevation view of the flagpole shown in FIG. 8.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

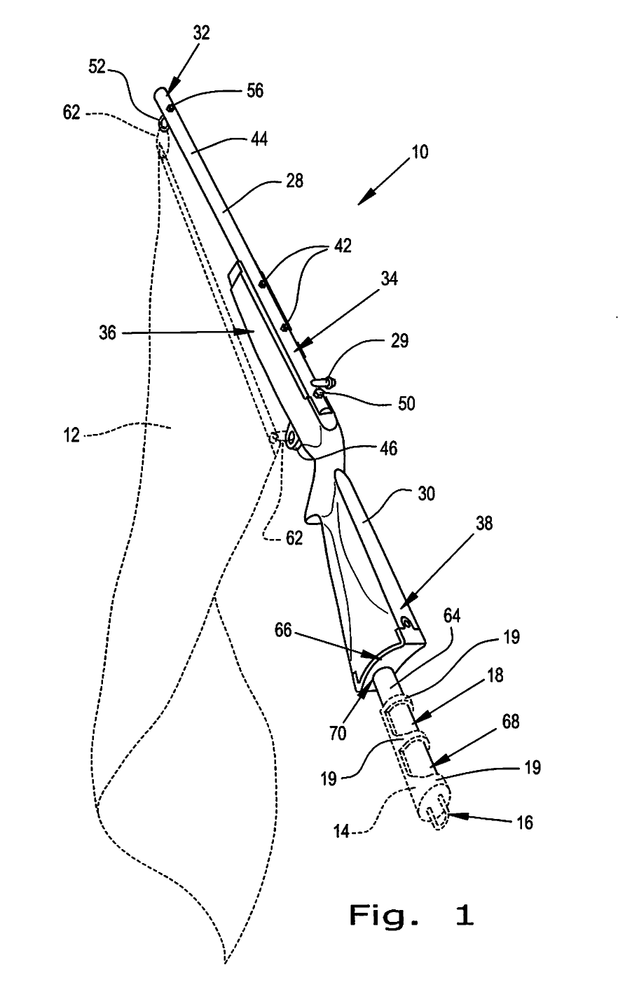

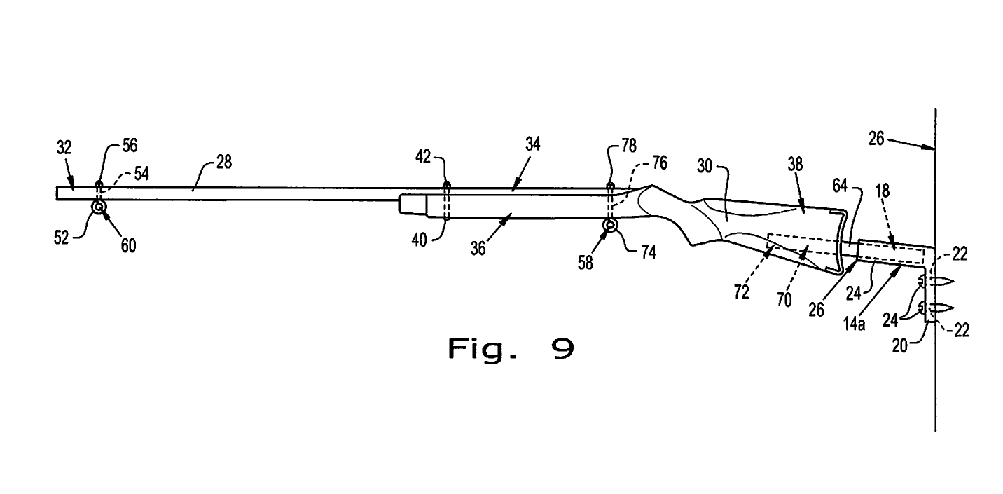

A rifle shaped flagpole constructed in accordance with the principles of the present invention is shown and generally designated in the drawings with the numeral 10. Flagpole 10 is adapted to carry and display a flag 12 such as the American flag, a state flag, etc., and is also adapted to be supported on a flagpole holder of a type that is commonly available. For example, the flagpole holder 14 shown in FIG. 1 includes a U-shaped means 16 for securing to a house, building, vehicle, boat, etc. Flagpole holder 14 includes a longitudinal bore 18 defined by ring portions 19 for receiving the terminal bottom end of common flagpoles. Another example of a flagpole holder is shown in FIGS. 8 and 9 and is designated by the numeral 14a. Flagpole holder 14a includes a bracket means 20 having holes 22 for receiving fastener screws 24 therethrough and securing to a vertical wall 26. The longitudinal bore 18 of flagpole holder 14a is provided in an arm 24 which extends at an angle from the bracket means 20. The longitudinal bore 18 extends into the arm 24 from its terminal end 26.

Flagpole 10 includes an elongate barrel portion 28 and a stock portion 30. The barrel portion 28 is preferably made of aluminum, treated/painted steel, plastic, or other weather resistant material, and the stock portion 30 is preferably made of plastic or treated/painted wood. The barrel portion 28 includes a muzzle end 32 and a chamber end 34 at its opposing ends thereof. A bolt 29 can be secured to and extend generally perpendicular from the barrel chamber end 28. The stock portion 30 includes a forestock part 36 and a butt part 38 at its opposing ends thereof. The barrel chamber end 34 overlaps the forestock part 36. Part of the barrel portion 28 and muzzle end 32 thereby extend longitudinally beyond the forestock part 36.

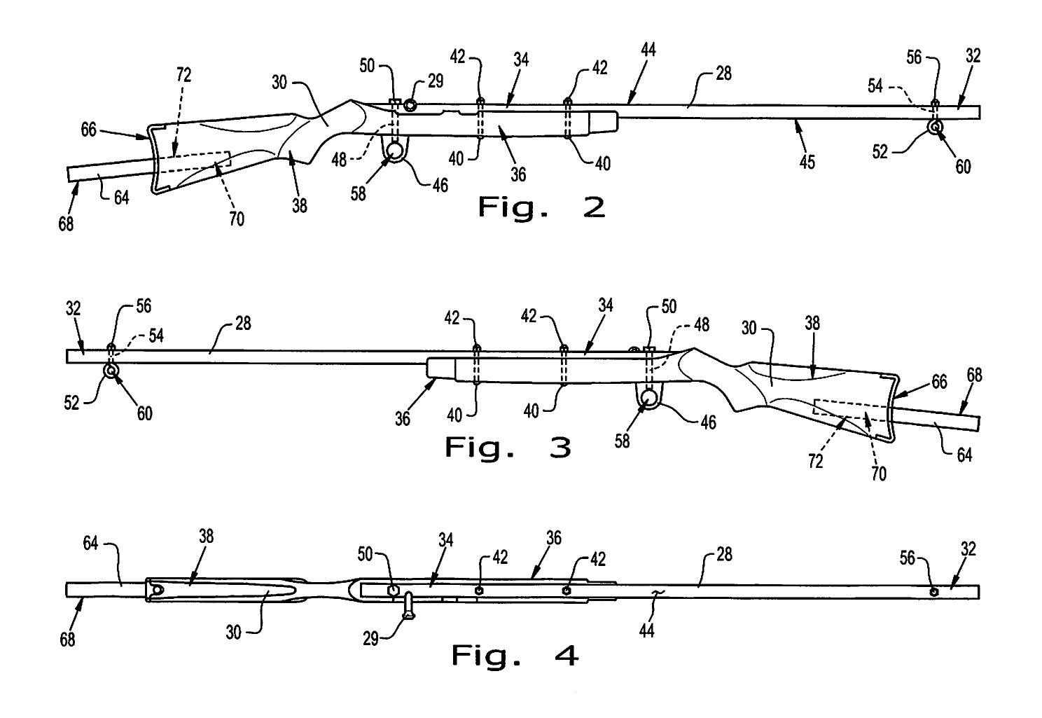

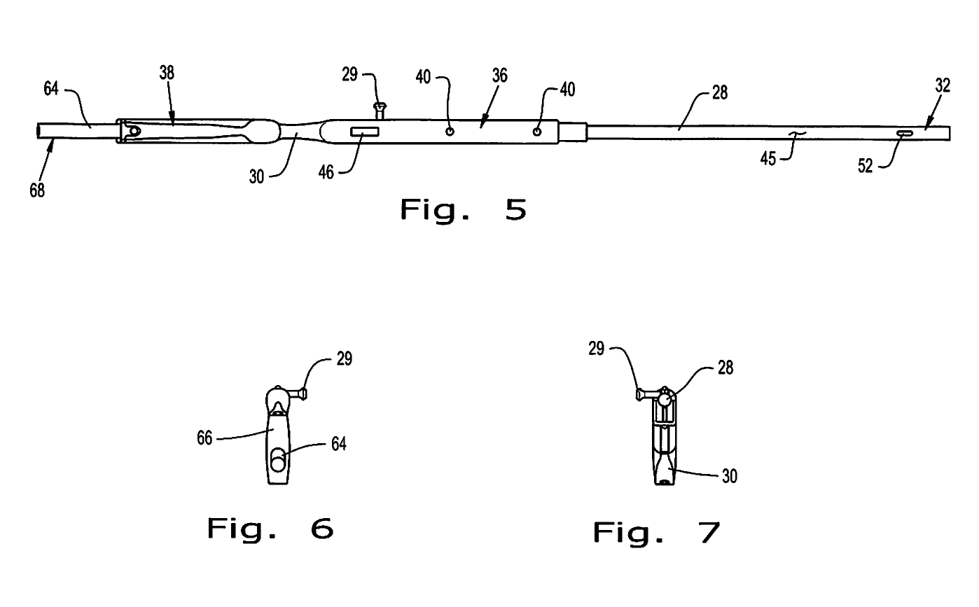

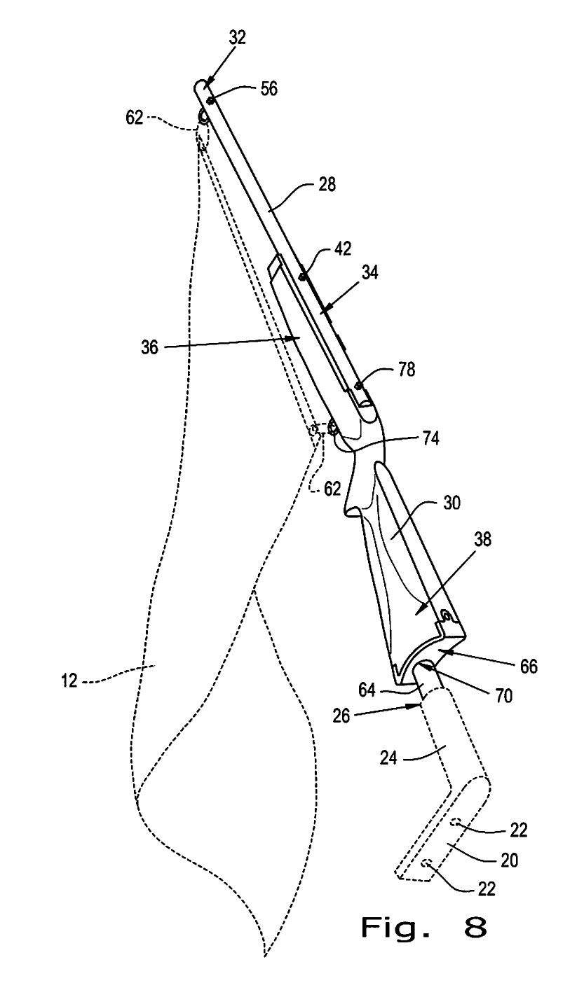

As best seen in FIGS. 2 and 3, barrel portion 28 is secured to the stock portion 30 with fastener screws 40 which extend through aligned holes in the forestock 36 and barrel chamber end 34 and which receive a nut 42 at their threaded terminal ends. The nuts 42, as shown, rest on the top surface 44 of the barrel 28 and thereby form aiming sights.

A trigger ring 46 includes a threaded bore 48 and is secured to the stock portion 30 for thereby forming a trigger guard. In this regard, a bolt 50 extends through aligned holes in the stock portion 30 and barrel chamber end 34 and is threadingly received in the threaded bore 48. The head of the bolt 50 rests on the barrel top surface 44 and also thereby forms an aiming sight.

An eye bolt 52 is fastened to the barrel portion 28 near the muzzle end 32. The eye bolt 52 includes a threaded portion 54 which extends through a hole in the barrel portion from the bottom surface 45 to the top surface 44. A nut 56 is threadingly received on the terminal end of the threaded portion 54 and rests on the top surface 44 and forms an aiming sight.

As should now be appreciated, the trigger ring 46 and eye bolt 52 form respective eyelets 58 and 60 whereat a flag 12 can be attached using threaded chain links 62 or other equivalent known link mechanisms.

Flagpole 10 is further provided with an elongate rod 64 extending longitudinally beyond the terminal end 66 of the stock butt part 38. Hence, a terminal end 68 of elongate rod 64 extends from the stock portion 30 in a direction generally opposite the barrel portion 28. The other/opposite terminal end 70 of the rod 64 is received in a bore 72 which extends into the stock portion 30 from the terminal end 66 of the butt part 38.

Rod 64 has a round shaped exterior surface and is preferably made of wood or plastic. The rod end 70 is frictionally secured and/or is secured in the bore 72 with an adhesive. Most preferably, rod 64 is solid, has a diameter of about one inch and extends out from the butt terminal end 66 about four inches. As shown in FIGS. 1 and 9, the terminal end 68 of elongate rod 64 is received in the longitudinal bore 18 of the holder 14 whereby the flagpole 10 can be supported and a flag 12 carried and displayed.

In the embodiment shown in FIGS. 8 and 9 one of the fastener screws 40 and the trigger ring 46 have been omitted and, instead, another eye bolt 74 is fastened to the stock portion 30 and barrel portion 28. The eye bolt 74 includes a threaded portion 76 which extends through aligned holes in both the stock portion 30 and barrel portion 28. A nut 78 is threadingly received on the terminal end of the threaded portion 76 thereby securing the barrel portion 28 and the stock portion 30 to one another. The nut 78 rests on the top surface 44 of the barrel portion 28 and forms an aiming sight. Additionally, as should now be appreciated, the eye bolt 74 forms the eyelet 58 whereat a flag 12 can be attached using a threaded chain link 62 or other equivalent known link mechanisms. Eye bolt 74 advantageously also replaces the trigger ring 46 and forms a trigger guard.

While this invention has been described as having an exemplary design, the present invention may be further modified within the spirit and scope of this disclosure. This application is therefore intended to cover any variations, uses, or adaptations of the invention using its general principles.

What is claimed is:

1. A rifle shaped flagpole adapted to carry a flag and be supported on a flagpole holder having an elongate bore, said flagpole comprising:
a barrel portion and a stock portion, said stock portion including a forestock part and a butt part at opposing ends thereof;
wherein said barrel portion extends longitudinally beyond said forestock part; and,
an elongate rod extending from said stock portion and adapted to be received in a flagpole holder elongate bore.

2. The rifle shaped flagpole of claim 1 further comprising:
a barrel eyelet near a barrel muzzle end on said barrel portion; and,
a stock eyelet on said stock portion, whereby a flag can be attached to said eyelets.

3. The rifle shaped flagpole of claim 2 wherein said barrel eyelet is part of an eye bolt fastened to said barrel portion and said stock eyelet is part of an eye bolt fastened to said stock portion.

4. The rifle shaped flagpole of claim 3 wherein said barrel eye bolt includes a portion extending through said barrel and forms an aiming sight and said stock eye bolt includes a portion extending through said stock and forms an aiming sight.

5. The rifle shaped flagpole of claim 2 wherein said stock eyelet is part of an eye bolt having a portion extending through said stock portion and said barrel portion whereby said stock portion and said barrel portion are secured to one another.

6. The rifle shaped flagpole of claim 1 wherein said elongate rod extends longitudinally beyond said stock portion butt part.

7. The rifle shaped flagpole of claim 6 wherein said elongate rod extends from said stock portion in a direction generally opposite said barrel portion.

8. The rifle shaped flagpole of claim 7 wherein said elongate rod has a round shaped surface.

9. The rifle shaped flagpole of claim 8 wherein said elongate rod has a diameter of about one inch and extends from said butt part about four inches.

10. The rifle shaped flagpole of claim 8 wherein one terminal end of said elongate rod is received and secured in a bore extending into said stock portion from said butt part and another terminal end of said elongate rod extends from said stock portion butt part and is adapted to be received in a flagpole holder elongate bore.

11. The rifle shaped flagpole of claim 10 further comprising:
a barrel eyelet near a barrel muzzle end on said barrel portion; and, a stock eyelet on said stock portion, whereby a flag can be attached to said eyelets.

12. The rifle shaped flagpole of claim 11 wherein said barrel eyelet is part of an eye bolt fastened to said barrel portion and said stock eyelet is part of an eye bolt fastened to said stock portion.

13. The rifle shaped flagpole of claim 12 wherein said barrel eye bolt includes a portion extending through said barrel and forms an aiming sight and said stock eye bolt includes a portion extending through said stock and forms an aiming sight.

14. The rifle shaped flagpole of claim 10 wherein one terminal end of said elongate rod is received and secured in a bore extending into said stock portion from said butt part and another terminal end of said elongate rod extends from said stock portion butt part and is adapted to be received in a flagpole holder elongate bore.

15. The rifle shaped flagpole of claim 14 further comprising:
a barrel eyelet near a barrel muzzle end on said barrel portion; and,
a stock eyelet on said stock portion, whereby a flag can be attached to said eyelets.

16. The rifle shaped flagpole of claim 15 wherein said barrel eyelet is part of an eye bolt fastened to said barrel portion and said stock eyelet is part of an eye bolt fastened to said stock portion, and wherein said barrel eye bolt includes a portion extending through said barrel and form an aiming sight and said stock eye bolt includes a portion extending through said stock and form an aiming sight.

17. The rifle shaped flagpole of claim 1 wherein said elongate rod extends from said stock portion in a direction generally opposite said barrel portion.

18. The rifle shaped flagpole of claim 1 wherein said elongate rod has a round shaped surface.

19. The rifle shaped flagpole of claim 1 wherein one terminal end of said elongate rod is received and secured in a bore in said stock portion and another terminal end of said elongate rod extends from said stock portion and is adapted to be received in a flagpole holder elongate bore.

20. The rifle shaped flagpole of claim 1 further comprising:
a barrel eyelet near a barrel muzzle end on said barrel portion and a stock eyelet on said stock portion whereby a flag can be attached to said eyelets;
wherein said barrel eyelet is part of an eye bolt fastened to said barrel portion, said barrel eye bolt including a portion extending through said barrel and forming an aiming sight; and,
wherein said stock eyelet is part of an eye bolt having a portion extending through said stock portion and said barrel portion securing said stock portion and said barrel portion to one another and forming an aiming sight.
